(19) United States
(12) Patent Application Publication
(10) Pub. No.: US 2008/0105336 A1
(43) Pub. Date: May 8, 2008

(54) Method and Means for Operating An Oxygen Cutting Machine For Oxygen Cutting of Cast Strands and Workpieces

(76) Inventor: Horst K. Lotz, Hauterive/NE (CH)

Correspondence Address: THE WEBB LAW FIRM, P.C., 700 KOPPERS BUILDING, 436 SEVENTH AVENUE, PITTSBURGH, PA, 15219, US

(21) Appl. No.: 11/929,378

(22) Filed: Oct. 30, 2007

(30) Foreign Application Priority Data
Oct. 30, 2006 (DE) 10 2006 051 044.5

(51) Int. Cl. B23K 7/00

(52) U.S. Cl. 148/195; 148/194

(57) ABSTRACT

In a method and means for operating an oxygen cutting machine for oxygen cutting of cast strands and workpieces the pressure and flow of the heating gas and heating oxygen are varied during the oxygen cutting process on the cast strand and/or workpiece with the pressure and the quantity of the heating gas and heating oxygen from the beginning to the end of the cutting path being reduced stepwise by at least 25%. During this process a constantly good quality of the cut surface on the workpiece is provided and the quantities of gas required for the oxygen cutting are reduced.

The invention relates to a method and means for operating an oxygen cutting machine for oxygen cutting of cast strands and steel workpieces in cold and hot condition in or downstream of continuous steel casting plants for blooms and slabs.

For further processing into lengths corresponding to the final products and which are portable, continuously cast steel strands must be subdivided in continuous casting plants. These mainly hot slabs and blooms are usually separated by oxygen cutting torches on an oxygen cutting machine. On such an oxygen cutting machine an oxygen cutting stream and/or cutting flame transforms the steel brought to ignition temperature into a discharging oxide slag thus creating a joint growing into a cut during movement. The cutting machine design is especially destined for flame cutting of round, square and rectangular shapes with diameters and sections up to approx. 350 mm.

In order to control pressure and flow of the heating gas and the heating oxygen for the cutting torch, pressure reducers are used. The pressure reducer is only adjusted once and operates according to this setting, namely with the always constant gas flow and gas pressure.

During the cutting process on the cast strand and/or workpiece, hereinafter only called workpiece, cold areas occur at its beginning and end since these have not yet been heated up or have not yet been sufficiently heated up by the cutting torch. Especially at the beginning of the cutting process, heating gas and heating oxygen with a high pressure and in great quantities is therefore required so that a rapid heating of the workpiece occurs and the required ignition temperature for flame cutting is achieved as rapidly as possible.

But since statically adjusted pressure reducers are used for pressure and flow control of the heating gas and the heating oxygen for the cutting torch, which during the cutting process make available heating gas and heating oxygen to the cutting torch at always the same pressure and the same quantity, the quality of the cut surface on the workpiece suffers as a result. Hence, the cut surface is unsatisfactory above all at the beginning and at the end of the cutting process. But the entire cut surface should rather have a constantly good quality.

Disadvantageous is moreover that unnecessarily great quantities of heating gas and heating oxygen are consumed, which are of course so much greater, the higher the pressure of the gases used during cutting is.

It is the objective of the invention to provide a method and means of the type mentioned above providing a constantly good quality of the cut surface on the workpiece and reducing the required gas quantities for flame cutting.

According to the invention the objective is achieved by a procedure in which the pressure and flow of the heating gas and the heating oxygen are reduced during the flame cutting process on the cast strand and/or workpiece with the pressure and quantity of the heating gas and the heating oxygen from the beginning to the end of the cutting path after a first portion of the cutting path, in which pressure and quantity of the heating gas and the heating oxygen are 100%, are reduced stepwise by at least 25%.

By this procedure an optimum adjustment of the cutting flame of the cutting nozzle of the cutting torch over the entire cutting area of the workpiece, i.e. from the beginning to the end of the cutting process, is achieved.

As has been explained in the beginning, at the beginning and at the end of the workpiece, a bloom or a slab cold areas occur since these have not yet or not yet sufficiently been heated up by the cutting torch. Thus, a slow cutting speed during initial cutting of the workpiece would be necessary, e.g. approx. 30 to 50% of the actual cutting speed. In the case of a workpiece with a cutting edge length of 200 mm for example, the cutting speed would have to be reduced accordingly to a portion of approx. 40 mm. In the second portion of approx. 120 mm of the workpiece, however, the maximum cutting speed would have to be increased to 100%. Finally, the cutting speed would be reduced again to approx. 30 to 50% in the third portion of approx. 40 mm of the workpiece so that a good cutting area is still created.

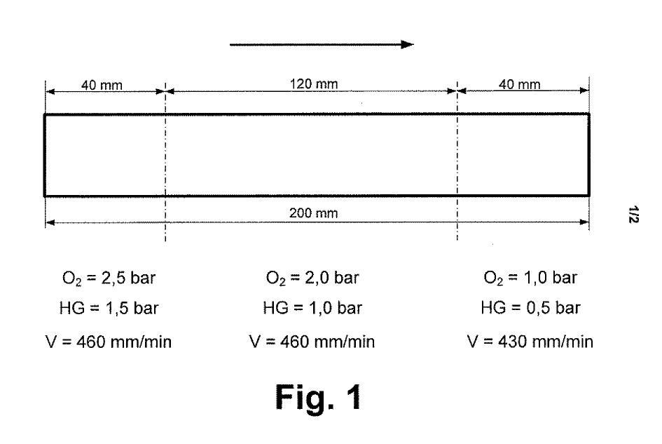

But according to the inventive procedure, the cutting speed can remain substantially constant over the entire cutting edge length. For this purpose, pressure and flow of the heating gas and the heating oxygen are modified during the cutting process on the cast strand and/or workpiece. Under test conditions carried out so far, by way of example, the changes of pressure—and thus also of the flow dependent on pressure—of the heating gas, e.g. natural gas, and the heating oxygen on the cutting torch are explained in FIG. 1 on a workpiece out of St37 with a cutting edge length of 200 mm with the cutting oxygen pressure being constantly 15 bar:

Pressure setting in the first portion of the workpiece:

| | | |
|---|---|---|
| heating oxygen (O2) | 2.5 | bar |
| heating gas (HG) | 1.5 | bar |
| at cutting speed (V) | 460 | mm/min. |

Pressure setting in the second portion of the workpiece:

| | | |
|---|---|---|
| heating oxygen (O2) | 2.0 | bar (reduced) |
| heating gas (HG) | 1.0 | bar (reduced) |
| at cutting speed (V) | 460 | mm/min. |

Pressure setting in the third portion of the workpiece:

| | | |
|---|---|---|
| heating oxygen (O2) | 1.0 | bar (reduced) |
| heating gas (HG) | 0.5 | bar (reduced) |
| at cutting speed (V) | 430 | mm/min. |

At the end of the cutting process the cutting speed was slightly reduced.

The cutting behavior of the cutting torch and the cutting area can be identified as being very good. For the pressure and cutting speed parameters mentioned, hence safe flame cutting with a good result is possible. Despite a more rapid cutting compared with the conventional cutting process—since the cutting speed was almost kept constant over the entire cutting edge—gas pressure and gas flow of heating gas and heating oxygen were reduced by at least 25%, namely:

First Portion

heating oxygen=100%

heating gas=100%

Second Portion

heating oxygen=80%—>20% reduction

heating gas=66%—>33% reduction

Third Portion

heating oxygen=60%—>40% reduction

heating gas=33%—>66% reduction.

This means in turn that the heating gas and heating oxygen consumption are reduced to at least 75%, hence a reduction by at least 25% becomes possible. In a continuously operated slab or bloom cutting machine hence per cut strand with two cutting torches approx. 10,000 =C/year of heating gas and heating oxygen can be saved.

Further characteristics and advantages of the invention result from the dependent claims.

According to another embodiment of the inventive method, the pressure and flow of the heating gas and the heating oxygen are regulated during the cutting process on the cast strand and/or workpiece by means of a membrane-controlled pressure measuring and pressure regulating valve with pressure and flow converters and by an electric and/or electronic control system and on the basis of predetermined reference values a cutting nozzle of a cutting torch is supplied with heating gas and heating oxygen varying in pressure and flow. By this, the pressure measuring and pressure regulating valve can be permanently varied from outside.

Moreover, for stepwise variation of the pressure and flow, the heating gas and the heating oxygen during the cutting process is supplied and discharged via the membrane to the membrane-controlled pressure measuring and pressure regulating valve until the pressure converters and flow converter report the reference values or their deviations reached each time to the electric and/or electronic control system which on the basis of the predetermined reference values processes comparative and adjustment or measuring values for control of the variation of supply and discharge of the heating gas and the oxygen gas.

According to further development of the procedure, the membrane-controlled pressure measuring and pressure regulating valve creates at least two pressure ranges, namely a pressure range for initial cutting and a pressure range for further cutting of the cast strand and/or workpiece. This can be realized by controlling the membrane of the pressure measuring and pressure regulating valve by means of a pre-controller which varies the membrane deflection of the pressure regulating valve. By this it can be controlled that less heating gas and heating oxygen gets to the cutting torch.

The objective is achieved according to the invention by a device of the type mentioned above, namely by a membrane-controlled pressure measuring and pressure regulating valve with a valve body having an upper and a lower valve chamber, and with valve dome, a spring-loaded push rod and with pressure and flow converters associated with a control system with the membrane on the valve dome being charged with a compressed gas for influencing gas flow and gas pressure for stepwise modification of the gas flow quantity and gas pressure by a pair of solenoid valves or a proportional valve associated with the control system, with the pressure converter and flow converter being arranged in the upper valve chamber and the pressure converter being arranged in the lower valve chamber.

This device has the same advantages and effectiveness as have been described above for the inventive method. This device permits variable supply of the cutting torch with heating gas and heating oxygen. In this connection it is also important that instead of usual statically adjustable pressure reducers, controllable pressure and flow converters are used for the cutting torch.

According to another embodiment of the inventive means, the pair of solenoid valves or the proportional valve is associated with an electric and/or electronic control system, processing comparative and adjustment or measured values on the basis of predetermined reference values for controlling variation of supply and discharge of the gas, and if necessary, for state detection and state information.

Moreover it is important that each one membrane-controlled pressure measuring and pressure regulating valve for heating gas and heating oxygen are provided for variation of the pressure and flow quantity of the heating gas and the heating oxygen during the cutting process.

It is self-evident that the above mentioned characteristics and the characteristics still to be explained can be used not only in the combination specified but also in other combinations or alone without abandoning the scope of the present invention.

The inventive idea is described in detail in the following description by means of an embodiment illustrated in the drawings in which

FIG. 1 is the schematic view of the variation of the pressure of the heating gas and the heating oxygen on a workpiece, and

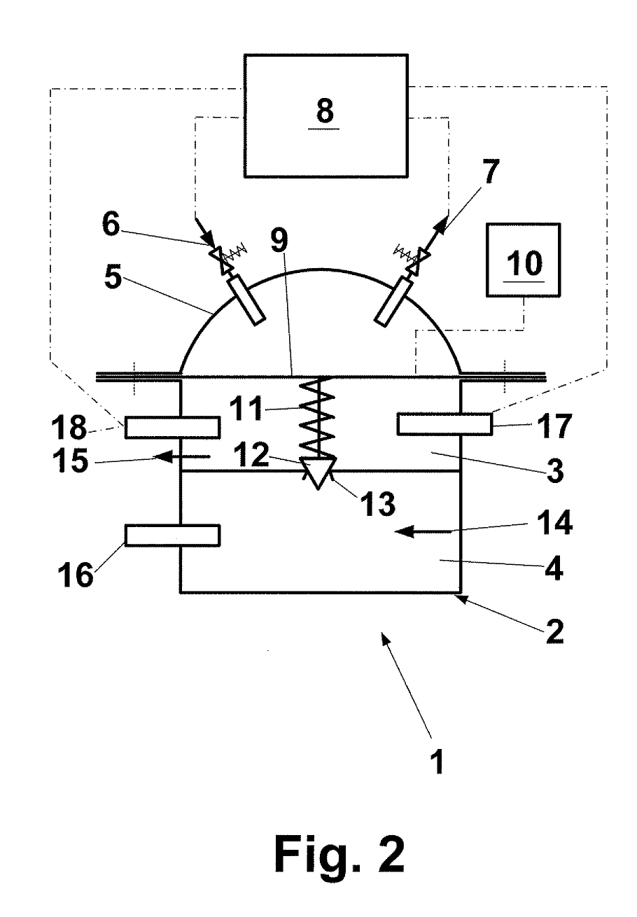

FIG. 2 illustrates schematically a membrane-controlled pressure measuring and pressure regulating valve for a means for safe and economical oxygen cutting of cast strands and workpieces out of steel in cold and hot condition in or downstream of continuous steel casting plants for billets, blooms and slabs.

The pressure measuring and pressure regulating valve 1 for heating gas and heating oxygen comprises a valve body 2 with an upper valve chamber 3 and a lower valve chamber 4. Moreover, a cupola-like valve dome 5 is placed onto the valve body 2. It has an inlet valve 6 and an outlet valve 7, which are associated with an electric and/or electronic control system 8 and are formed as a solenoid valve or as a proportional valve.

Between the upper valve chamber 3 and the valve dome 5 a membrane 9 is arranged, which is connected to a pre-controller 10 modifying the membrane deflection of the pressure measuring and pressure regulating valve 1. For stepwise variation of gas flow and gas pressure, membrane 9 is charged with a compressed gas for influencing gas flow and gas pressure through the inlet valve 6 and the outlet valve 7 on valve dome 5.

A valve push rod 12 charged with a compression spring 11 rests on membrane 9 opening and closing an opening 13 between the upper valve chamber 3 and the lower valve chamber 4 of valve body 2 depending on the motion of the membrane 9 with gas flowing into the lower valve chamber 4 according to arrow 14 and gas discharging at the upper valve chamber 3 according to arrow 15.

In the lower valve chamber 4 a pressure converter 16 and at the upper valve chamber 3 a pressure converter 17 and a flow converter 18 are arranged which are connected to the control system 8.

By means of the pressure measuring and pressure regulating valve 1 a gas flow according to a predetermined reference value of flow pressure and thus also of flow quantity is controlled and regulated via gas inlet 14 and gas outlet 15 resp. The reference value is generated by inflow of a gas flow with higher pressure via the inlet valve 6 or outflow of the existing gas via the outlet valve 7 for generation of a lower pressure via membrane 9.

The differential pressure above and below membrane 9 varies in co-operation with compression spring 11 the opening 13 for modification of the gas flow passing through so that the gas flow desired is discharged at the gas outlet 15 with the desired pressure. The pressure converters 16, 17 and the flow converter 18 convert the gas pressures and gas quantities detected into electric signals, which are transmitted to the control system 8, permitting comparison with the adjustment values stored in the control system, from which control signals for opening and closing of the inlet valve 6 and the outlet valve 7 on valve dome 5 of the pressure measuring and pressure regulating valve 1 are then delivered.

### LIST OF REFERENCE NUMERALS

| | pressure measuring and pressure regulating valve |
|---|---|
| | valve body |
| | upper valve chamber |
| | lower valve chamber |
| | valve dome |
| | inlet valve (solenoid valve) |
| | outlet valve (solenoid valve) |
| | control system |
| | membrane |
| 0 | pre-controller |
| 1 | compression spring |
| 2 | valve push rod |
| 3 | opening |
| 4 | gas inlet |
| 5 | gas outlet |
| 6 | pressure converter |
| 7 | pressure converter |
| 8 | flow converter |

1. A method for operating an oxygen cutting machine for oxygen cutting of cast strands and steel workpieces in cold and hot conditions in or downstream of continuous steel casting plants for blooms and slabs, wherein the pressure and flow of heating gas and heating oxygen are reduced during flame cutting process on the cast strand or workpiece with the pressure and quantity of the heating gas and the heating oxygen from the beginning to the end of a cutting path after a first portion of the cutting path, wherein the pressure and quantity of the heating gas and the heating oxygen are 100%, and are reduced stepwise by at least 25%.

2. The method according to claim 1, wherein the pressure and flow of the heating gas and the heating oxygen are regulated during the cutting process on the cast strand or workpiece by means of a membrane controlled pressure measuring and pressure regulating valve with pressure converters and flow converters and by an electric or electronic control system, and wherein on a basis of predetermined reference values, a cutting nozzle of a cutting torch is supplied with the heating gas and the heating oxygen varying in pressure and flow.

3. The method according to claim 2, wherein during the stepwise variation of the pressure and flow, the heating gas and the heating oxygen during the cutting process is supplied and discharged via the membrane of the membrane-controlled pressure measuring and pressure regulating valve until the pressure converters and flow converter report the reference values or their deviations reached each time to the electric or electronic control system, wherein on the basis of the predetermined reference values the control system processes comparative and adjustment or measuring values for control of the variation of supply and discharge of the heating gas and the oxygen gas.

4. The method according to claim 1, wherein the membrane-controlled pressure measuring and pressure regulating valve creates at least a first and second pressure range, wherein the first pressure range is adapted for initial cutting and the second pressure range is adapted for further cutting of the cast strand or workpiece.

5. The method according to claim 2, wherein the membrane of the pressure measuring and regulating valve is controlled by a pre-controller.

6. Means for operating an oxygen cutting machine for oxygen cutting of cast strands and workpieces out of steel in cold and hot conditions in or downstream of continuous steel casting plants for blooms and slabs, comprising:
a membrane-controlled pressure measuring and pressure regulating valve; having
a valve body having an upper and a lower valve chamber;
a valve dome;
a spring-loaded push rod; and
a first and second pressure converter and a flow converter associated with a control system, wherein the membrane of the membrane-controlled pressure measuring and pressure regulating valve on the valve dome is charged with a compressed gas for influencing gas flow and gas pressure for stepwise modification of the gas flow quantity and gas pressure by a pair of solenoid valves or a proportional valve associated with the control system, wherein the second pressure converter and flow converter are arranged in the upper valve chamber and the first pressure converter is arranged in the lower valve chamber.

7. The means according to claim 6, wherein the control system is electric or electronic and is configured to process comparative and adjustment or measured values on the basis of predetermined reference values for controlling variation of supply and discharge of the gas, and optionally, for state detection and state information.

8. The means according to claim 6, wherein the membrane-controlled pressure measuring and pressure regulating valve for heating gas and heating oxygen is configured to provide a variation of the pressure and flow quantity of the heating gas and the heating oxygen during the cutting process.
